(19) United States
(12) Patent Application Publication
(10) Pub. No.: US 2018/0211553 A1
(43) Pub. Date: Jul. 26, 2018

(54) SYSTEMS AND METHODS FOR PROVIDING PERSONALIZED ELECTRONIC LEARNING MATERIAL IN AN EDUCATIONAL INFRASTRUCTURE

(71) Applicant: ITSI HOLDINGS (PTY) LTD., Faerie Glen (ZA)

(72) Inventor: Jacobus LIEBENBERG, Pretoria (ZA)

(21) Appl. No.: 15/757,318

(22) PCT Filed: Sep. 2, 2016
(86) PCT No.: PCT/IB2016/055267

§ 371 Date: Mar. 2, 2018

(30) Foreign Application Priority Data
Sep. 2, 2015 (ZA) 2015/06426

(51) Int. Cl. G09B 5/08; G09B 5/06; G09B 7/04; G06Q 50/20

(52) U.S. Cl. CPC G09B 5/08; G09B 5/065; G06F 17/241; G06Q 50/205; G09B 7/04

(57) ABSTRACT

A system and method for providing personalized electronic learning material in an educational infrastructure is described. In a method conducted at a student device associated with a student and having a software application resident therein, access to a portable document format (PDF) file is received from a computerized server. The PDF file contains learning material. Access to student-specific educator content is received from the computerized server. The content is specific to the student and access thereto is pushed to the student device from an educator device via the computerized server. The student-specific educator content is associated with the PDF file. The PDF file and student-specific educator content associated therewith are accessed and the student-specific educator content is superimposed onto the PDF file. The PDF file having the student-specific educator content superimposed thereon is output to the student.

### CROSS-REFERENCE TO RELATED APPLICATIONS

This application claims priority from South African provisional patent application number 2015/06426 filed on 2 Sep. 2015, which is incorporated by reference herein.

### FIELD OF THE INVENTION

This invention relates to the use and control of information communication technology in the educational field for the education of students typically with the assistance or input of educators. In particular, the invention relates to systems and methods for providing personalized electronic learning material in an educational infrastructure.

### BACKGROUND TO THE INVENTION

The use of Information Communication Technology (ICT) is becoming an integral part of our modern-day society, from an early age onwards. Students need to be fluent in its use for learning, leisure and academic work. It is becoming an efficient medium for finding and using information as part of the learning process. It therefore appears that Information Communication Technology should advantageously be integrated with the learning curriculum of students.

It is envisaged that by utilizing an effective strategy students can be encouraged and guided to effectively utilize available Information Communication Technology resources to improve their quality of work and presentation skills across all subjects.

One way of providing information to students is via a Portable Document Format (PDF) file. The PDF file format is typically used to present documents in a manner independent of application software, hardware and operating systems. Each PDF file generally encapsulates a complete description of a fixed-layout flat document, including the text, fonts, graphics and other information needed to display it.

While the PDF file format allows for several different kinds of data to be contained within a file and may make provision for “annotations”, such as highlights, additional text and even other files to be included within the PDF file, these additions typically alter the PDF file, such that the file is enlarged with this additional information. More so, it is usually required that these additions actually be input by users using a PDF reader that has the functionality to do so.

Such limitations may hinder the implementation of PDF documents in an educational infrastructure where personalized electronic learning material is provided to students.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention, there is provided a computer-implemented method for providing personalized electronic learning material in an educational infrastructure, the method being conducted at a student device associated with a student and having a software application resident therein, the method including the steps of:
receiving, from a computerized server, access to a portable document format (PDF) file, the PDF file containing learning material;
receiving, from the computerized server, access to student-specific educator content, the content being specific to the student and access thereto having been pushed to the student device from an educator device via the computerized server;
associating the student-specific educator content with the PDF file; and,
responsive to receiving student input to open the PDF file, accessing the PDF file;
accessing the student-specific educator content associated with the PDF file;
superimposing the student-specific educator content onto the PDF file; and,
outputting, to the student, the PDF file having the student-specific educator content superimposed thereon.

Further features provide for the educational infrastructure to operate on a cloud principle in which the software application is hosted by the computerized server and in which the student device utilises the software application via a communication network; for the software application to perform the steps of: accessing the PDF file; accessing the student-specific educator content associated with the PDF file; superimposing the student-specific educator content onto the PDF file; and, outputting the PDF file having the student-specific educator content superimposed thereon; for the step of receiving access to a portable document format (PDF) file to receive access to an instance of a PDF file stored at the computerized server, and for the step of associating the student-specific educator content with the PDF file to include storing the student-specific educator content at the computerized server in association with the instance of the PDF file.

A yet further feature provides for the step of superimposing the student-specific educator content onto the PDF file or instance thereof not to alter the PDF file or instance thereof. The PDF file or instance thereof thus remains intact and the student-specific educator content does not alter the structure of the PDF file or instance thereof, thereby ensuring that the PDF file or instance thereof may be safely regarded as untouched and original.

A still further feature provides for the step of superimposing the student-specific educator content onto the PDF file to be performed without intervention from the student.

Further features provide for the student-specific educator content to include timing data, and for the timing data to instruct a point in time at which the student-specific educator content is superimposed onto the PDF file.

A still further feature provides for the student-specific educator content to include location data specifying locations within the PDF file at which the student-specific educator content is to be superimposed.

In this way, an educator using an educator device may drop student-specific content into individual or groups of students' instances of their PDF files without altering the PDF file or instance thereof.

The invention extends to a computer-implemented method for providing personalized electronic learning material in an educational infrastructure, the method being conducted at a computerized server capable of communicating with a student device associated with a student and having a software application resident therein, the method including the steps of:
providing, to the student device, access to a portable document format (PDF) file, the PDF file containing learning material; and,
providing, to the student device, access to student-specific educator content, the content being specific to the student and access thereto having been pushed from an educator device, such that the student device is operable to associate the student-specific educator content with the PDF file and superimpose the student-specific educator content onto the PDF file for output to the student.

Further features provide for the educational infrastructure to operate on a cloud principle in which a software application is hosted by the computerized server and in which the student device utilises the software application via a communication network; and for the method to include steps of:
associating the student-specific educator content with the PDF file; and,
responsive to receiving, via the communication network, student input to open the PDF file, accessing the PDF file;
accessing the student-specific educator content associated with the PDF file;
superimposing the student-specific educator content onto the PDF file; and
outputting, to the student device via the communication network, the PDF file having the student-specific educator content superimposed thereon.

Yet further features provide for the step of providing access to a portable document format (PDF) file to provide access to an instance of a PDF file, and for the step of associating the student-specific educator content with the PDF file to store the student-specific educator content at the computerized server in association with the instance of the PDF file.

The invention extends to a system for providing personalized electronic learning material in an educational infrastructure, the system including a student device associated with a student and having a software application resident therein, the student device including:
a PDF receiving component for receiving, from a computerized server, access to a portable document format (PDF) file, the PDF file containing learning material;
an educator content receiving component for receiving, from the computerized server, access to student-specific educator content, the content being specific to the student and access thereto having been pushed to the student device from an educator device via the computerized server;
an associating component for associating the student-specific educator content with the PDF file; and,
a PDF file interaction interface configured to, responsive to receiving student input to open the PDF file:
   access the PDF file;
   access the student-specific educator content associated with the PDF file;
   superimpose the student-specific educator content onto the PDF file; and
   output, to the student, the PDF file having the student-specific educator content superimposed thereon.

A further feature provides for the system to include a computerized server capable of communicating with the student device, the computerized server including:
a PDF providing component for providing, to the student device, access to a portable document format (PDF) file, the PDF file containing learning material; and,
an educator content providing component for providing, to the student device, access to student-specific educator content, the content being specific to the student and access thereto having been pushed from an educator device, such that the student device is operable to associate the student-specific educator content with the PDF file and superimpose the student-specific educator content onto the PDF file for output to the student.

The invention extends to a computer program product for providing personalized electronic learning material in an educational infrastructure including a student device associated with a student and having a software application resident therein, the computer program product comprising a computer-readable medium having stored computer-readable program code for performing the steps of:
receiving, from a computerized server, access to a portable document format (PDF) file, the PDF file containing learning material;
receiving, from the computerized server, access to student-specific educator content, the content being specific to the student and access thereto having been pushed to the student device from an educator device via the computerized server;
associating the student-specific educator content with the PDF file; and,
responsive to receiving student input to open the PDF file, accessing the PDF file;
accessing the student-specific educator content associated with the PDF file;
superimposing the student-specific educator content onto the PDF file; and,
outputting, to the student, the PDF file having the student-specific educator content superimposed thereon.

The invention extends to a computer program product for providing personalized electronic learning material in an educational infrastructure including computerized server capable of communicating with a student device associated with a student and having a software application resident therein, the computer program product comprising a computer-readable medium having stored computer-readable program code for performing the steps of:
providing, to the student device, access to a portable document format (PDF) file, the PDF file containing learning material; and,
providing, to the student device, access to student-specific educator content, the content being specific to the student and access thereto having been pushed from an educator device, such that the student device is operable to associate the student-specific educator content with the PDF file and superimpose the student-specific educator content onto the PDF file for output to the student.

Further features provide for the computer-readable medium to be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1 is a schematic diagram showing an educational infrastructure on which aspects of this invention are operable;

FIG. 2A is a block diagram of example components of the educational infrastructure of FIG. 1;

FIG. 2B is a block diagram which illustrates components shown in FIG. 2A in greater detail;

FIG. 3A is a flow diagram of a method of operation of a server of the educational infrastructure of FIG. 1;

FIG. 3B is a swim-lane flow diagram which illustrates a method for providing personalized electronic learning material in an educational infrastructure;

FIG. 4A is a schematic diagram of a portable document format file and summary in accordance with an aspect of the present invention;

FIG. 4B is a flow diagram of an example method of generating a summary of a portable document format file in accordance with the aspect shown in FIG. 4A;

FIG. 5A is a schematic diagram of a portable document format file in accordance with aspects of the present invention;

FIG. 5B is a flow diagram of an example method of a portable document format file in accordance with the aspect shown in FIG. 5A;

FIG. 6 is a block diagram of an example system in accordance with further aspects of the present invention; and,

FIG. 7 is a block diagram of a data processing system in which aspects of the present invention may be implemented.

### DETAILED DESCRIPTION WITH REFERENCE TO THE DRAWINGS

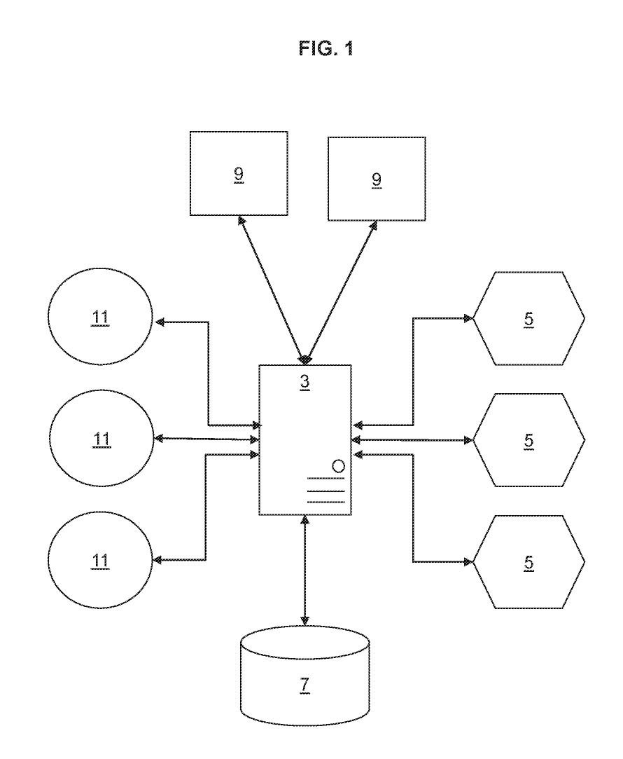

An educational infrastructure (1), as shown in FIG. 1, is provided in which an educational institution such as a school or college (not shown) has access to a computerized server (3) that is in operative communication with a multitude of communications devices (5) accessible to, and preferably personal to, students of the educational infrastructure who are individually identifiable by the computerized server (3) by way of identification data. Identification data may include data inputted from time to time by the individual students, license data issued by the computerized server (3) and submitted to the communications devices (5) upon initialization of the devices (5) and updated from time to time, digital signatures uniquely associated with student devices (5) or individual students, or combinations or variations of the aforementioned. In the very least, the individual students may conveniently be identified by way of a unique user name and individual password.

The communications devices (5) may take many different forms that will depend, at least to some extent, on the degree of sophistication of the educational institution and its students. Communication between the computerized server (3) and the communications device (5) may be wireless and it is envisaged that the communications devices (5) assume the form of the well-known electronic tablet. It is envisaged, however, that the communications devices (5) may be any suitable electronic device capable of communicating with the computerized server (3) via a communication network. Exemplary communications devices (5) include mobile phones (e.g. smart phones, feature phones, etc.), personal digital assistants, laptop computers, wearable electronic devices and the like.

The computerized server (3) and communications devices (5) may operate on a cloud principle in which the computerized server retains at least the majority of software and electronic data used by the students in an electronic data store (7), and a minimum amount of programming material is required on, and a minimum amount of processing is required to be performed by, the communications device (5). Whilst communications could take place via any suitable communication network, it is envisaged that a school's premises could provide a wireless data transmission network (e.g. a Wi-Fi zone) via which the devices and server (3) may communicate and via which access to the Internet may be provided. It should be apparent to those skilled in the art that communication between the server and communications devices may, however, be conducted over local area, wide area or distributed networks such as the Internet, and may include a combination of wireless, wired, near-field, mobile and radio communications techniques.

In general, the server (3) is configured to provide electronic content, most notably learning material in the form of portable document format (PDF) files (9), which could be books published in electronic format which contain learning material. As used herein, references to “portable document format” and “PDF” include references to the so-called “ePDF” which typically allows bookmarks, links within the PDF, links to other PDFs, show/hide fields, form fields, comment and mark-up annotations, rich media and the like.

The PDF files or instances thereof are individually licensed to individual students most commonly following an electronic purchase of the PDF file by the applicable student. To comply with copyright and electronic licensing restrictions and regulations, PDF files may be encrypted by the server or a provider so as to avoid onward and unauthorized distribution thereof by the student. Individual students may be provided with license keys enabling them to decrypt encrypted and download PDF files that they have purchased or are otherwise authorized to access. In this way access to and distribution of the PDF files may be controlled by the computerized server (3). The computerized server (3) may keep records of purchased PDF files and their associated licensing information and keys for each individual student, thereby enabling students to switch between devices without loss of access to licensed PDF files or built up content.

The computerized server (3) may be configured to monitor individual student activity on the relevant communications device (5) whilst the student utilizes learning material by way of the communications device. Such activity may be one or more or all of: time or frequency of note taking; time or frequency of highlights being made to educational content; time or frequency of exploring provided content put forward by educators; time or frequency of own content added to an PDF file or other book or other electronic material; validity of content appended by a student (related to current subject matter); quality of summaries generated by a student; time or frequency of opening or closing a give PDF file and the duration of use thereof.

The computerized server (3) may thus be configured to record data as to the nature and duration of student engagement with learning material of different types. The computerized server (3) may also maintain or have access to previous assessment information that may be used to identify a particular student's, or a class' problem areas of study.

Statistics may be gathered on a regular basis and a profile of each student may be built up. This profile would be unique to each student and could be compared to that of the remainder of the grade students, for the purpose of assessment, etc.

Simply by way of example, it may be detected that a particular student is studying for an upcoming test but for some reason is studying the wrong content in relation to the rest of the students in that grade. As this could be a mistake, the computerized server (3) may, either by virtue of its own programming, or on activation by an educator or other person, send a message to that student indicating that the current work being done by the student is not relevant to the upcoming test.

As a student progresses through the learning material, assessments may be provided from either an educator's intervention or from the system itself. It is feasible that other topics may be sourced for the assessment, based on what the student is currently doing, so that the current work is shown to be dependent on previous work. This will make the student reinforce the knowledge from previous sections.

Additionally, the computerized server (3) may be configured to learn that a student is struggling with the understanding of a particular area of study. This information should be provided to the relevant parties so that the student may be assisted and have the misunderstanding prevented, before it results in a more dire situation developing.

The reinforcement system may be a dual system, existing both on the server infrastructure and in a reader application of the student. The systems may communicate and work together to interact with the student. The server component may be responsible for mining the data from the student and generating a student profile, together with a profile for that grade of students. From this profile, the server can schedule frequent assessments and student interaction, from which the profile of the student may be updated and maintained.

Educators are provided access to learning material, and other data stored by the server (3) in the data store (7) from educator browsers (11), which could be dedicated systems installed at the educational institution, or web-based browsers which the educators may use to gain access to the server and stored information from any web-enabled device (e.g. tablet computers, laptop computers, mobile phones, etc.). Educators also have the capability to upload content to individual student profiles, interact with individual students or groups of students, create resources and attach resources to PDF files.

It will be appreciated that all educator as well as student data, whether delivered by the server or an independent Content Delivery Network (CDN) such as an independent publisher, or created by students or educators alike, may be stored by the server (3) in the data store (7). This enables all data to be entirely restorable to educator or student devices in the case of data loss on devices.

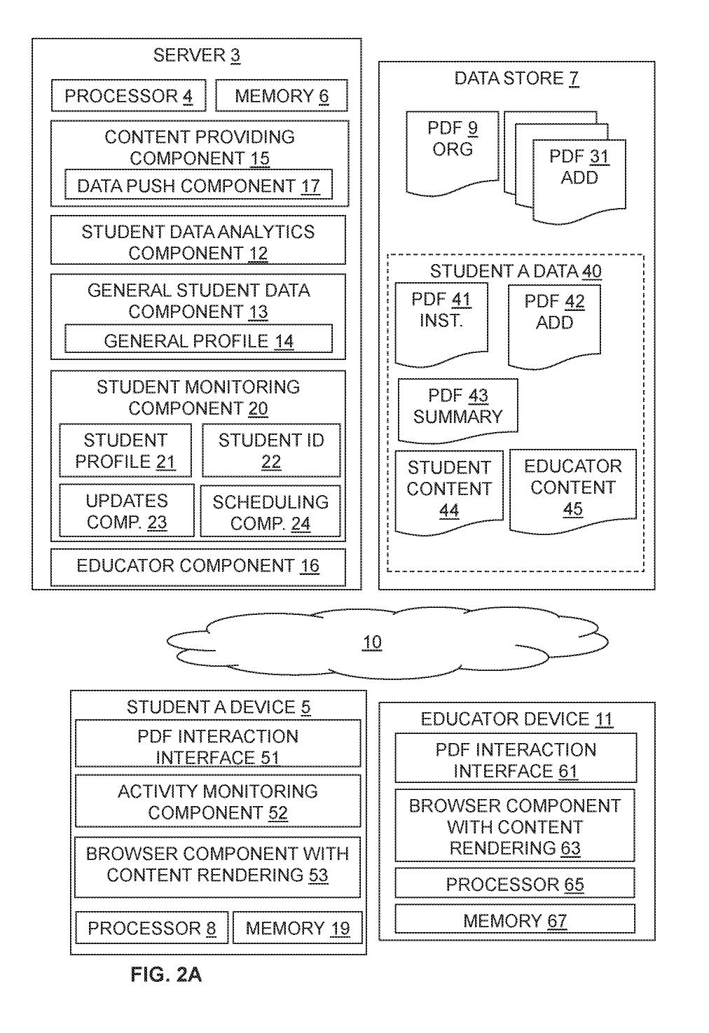

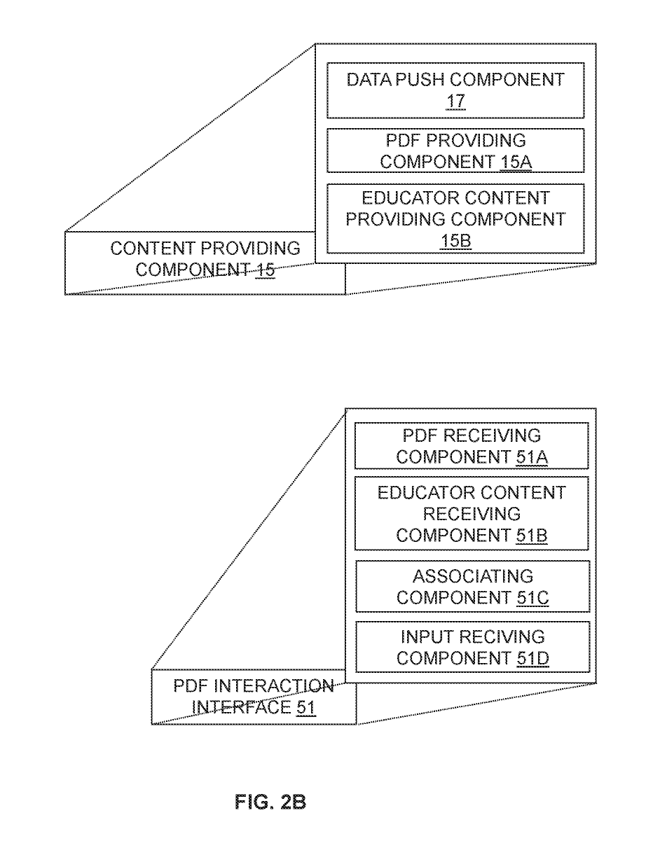

Referring to FIG. 2A, a block diagram illustrates an example embodiment of components of the described educational infrastructure.

The computerized server (3) may include a processor (4) for executing the functions of components described below, which may be provided by hardware or by software units executing on the computerized server (3). The software units may be stored in a memory (6) and instructions may be provided to the processor (4) to carry out the functionality of the described components.

The computerized server (3) may have access to a data store (7) which may be provided locally to or remotely from the server (3). A communication network (10) allows communication with a communications device of a student (5) (“student device”) and a communications device of an educator (11) (“educator device”). In this embodiment, a single student device (5) for a particular student (“student A”) is shown (and may be referred to as “student A device”) and a single educator device (11) associated with a particular educator is shown; however, it is understood that the infrastructure includes multiple student devices (5) and multiple educator devices (11), each of which is associated with its own student or educator as the case may be.

The server (3) may include a content providing component (15) for providing electronic content such as learning material in the form of PDF files (9) as well as PDF file additional content (31) for updating the PDF files (9) with additional content. The PDF file additional content (31) may be provided on the fly (e.g. autonomously without student or educator input) to student users. The content providing component (15) may include a data push component (17) which uses push technology between the server (3) and student devices (5) and educator devices (11) to push data from the server (3) to the student devices (5) and educator devices (11). “Push” may describe a style of Internet-based communication where the request for a given transaction is initiated by the publisher (e.g. the server in this instance). It is contrasted with pull/get, where the request for the transmission of information is initiated by the receiver or client.

Personalization of PDF files (9) is an effect of pushing the personalized information to the users directly.

Referring to FIG. 2B, the content providing component (15) also includes a PDF providing component (15A) for providing access to an instance of a PDF file (41) to the student device (5). The instance of the PDF file (41) to which access is provided may be an instance of the PDF file which is uniquely associated with student A. In the illustrated embodiment, the instance of the PDF file (41) is stored in the data store (7) in association with student A data (40). The content providing component (15) also includes an educator content providing component (15B) for providing access to student-specific educator content (45) to the student device (5). The student-specific educator content (45) may be specific to the student (i.e. student A in this scenario) or specific to a group of students, such as a class of students with which student A is associated.

An instance of a PDF file (41) may be accessed by a specific student and may be downloaded onto the student device (5) or utilised by the student device (5) remotely via the network (10). A downloaded instance of a PDF file (41) may be backed up to the data store (7) of the server (3) when the student device (5) is in network communication with the server (3). As mentioned above, an instance or references to the PDF file (41) may also be stored at a data store (7) of the server (3) for a specific student such as student A (40). Other data may be stored together with the PDF file instance or reference including PDF file additional content (42) for the particular student, a PDF file summary (43) developed by the student, student content (44), and educator content (45) which may be provided specifically for the particular student. The educator content (45) may include additional reading material associated with certain sections of the learning material contained within the PDF file, annotations, notes or hints to the student from the educator, questions to the student posed by the educator or the like. The student A data (40) may be stored at the data store (7) of the server (3) remotely from the student device (5) and the educator device (11) and updates may be pushed to the student device (5) and educator device (11). The student device (5) and the educator device (11) may have browser components (53, 63) with rendering capability for the various PDF file content and associated data and push notifications. In other implementations, the student A data may be stored locally at the student device (5). Although only one PDF file instance (41) and associated data is illustrated, it should be appreciated that in a practical scenario, each student may have multiple PDF file instances, each having its own associated data, for each original PDF which the student is required to use (e.g. one for each text book prescribed for a given year, semester, etc.).

The student device (5) may include a processor (8) for executing the functions of components described below, which may be provided by hardware or by software units executing on the student device (5). The software units may be stored in a memory component (19) and instructions may be provided to the processor (8) to carry out the functionality of the described components. In some cases, for example in a cloud computing implementation, software units arranged to manage and/or process data on behalf of the student device (5) may be provided remotely. Some or all of the components may be provided by a software application downloadable onto and executable on the student device (5).

The student device (5) may include a software application providing a PDF file interaction interface (51) for annotating, reading, adding content to, and otherwise interacting with the PDF file instance (41). A student may interact with multiple PDF file instances.

FIG. 2B shows the PDF file interaction interface (51) in greater detail. The PDF file interaction interface (51) may include a PDF receiving component (51A) arranged to receive access to an instance of a PDF file (41) from the computerized server (3). This may include downloading the instance (41) or receiving the required permissions to remotely access, read and/or write to the instance. The PDF file interaction interface (51) also includes an educator content receiving component (51B) arranged to receive, from the computerized server (3), access to student-specific educator content (45). Receiving access to the student-specific educator content may include downloading the content onto the student device (5) or receiving the required permissions to remotely access, read and/or write to the content. In some implementations, receiving access may require the student device (5) to provide identification data in order to verify that the student device (5) is permitted to access to the instance and/or content. Receiving access may accordingly include receiving authorization to access the instance and/or content responsive to the identification data being verified.

The PDF file interaction interface (51) further includes an associating component (51C) arranged to associate the student-specific educator content (45) with the instance of the PDF file (41) and an input receiving component (51D) arranged to receive student input to open the instance of the PDF file (41) for viewing. The PDF file interaction interface (51) is operable to, responsive to receiving input to open the instance of PDF file, access the instance of the PDF file (41), access the student-specific educator content (45) associated with the instance of the PDF file (41) and to superimpose the student-specific educator content (45) onto the instance of the PDF file (41). Accessing the instance of the PDF file (41) and accessing the student-specific educator content (45) may include opening or otherwise instantiating the instance and content respectively such that the student may interact with the instance and content respectively. The PDF file interaction interface (51) is further operable to output the instance of the PDF file having the student-specific educator content superimposed thereon to the student via a display associated with the student device (5) (e.g. a touch sensitive display in the case of a tablet computer).

Superimposing the student-specific educator content onto the instance of the PDF does not alter the instance of the PDF file. The instance of the PDF file thus remains intact and the student-specific educator content does not alter the structure of the instance of the PDF file (nor the PDF file itself), thereby ensuring that the PDF file or instance thereof may be safely regarded as untouched and original.

Furthermore, the PDF file interaction interface (51) is operable to superimpose the student-specific educator content onto the instance of the PDF file without intervention from the student. This is advantageous is it cuts down the time it would take for the student to manually incorporate educator content into the instance of the PDF file.

The student-specific educator content includes timing data which determines (i.e. instructs) the point in time at which, responsive to the software application receiving student input to open the instance of the PDF file, the student-specific educator content is superimposed onto the instance of the PDF file. The timing data may be event-based, e.g. the timing data may instruct that the student-specific educator content is superimposed responsive to the student reaching a particular point in the PDF, responsive to the student having completed a specific section, task, etc. In some cases, the timing data may be time-based, e.g. that the student-specific educator content is superimposed at a particular time on a particular date, etc. The student-specific educator content also includes location data specifying locations within the instance of the PDF file at which the student-specific educator content is to be superimposed. For example, the educator may wish for the student to first read a section of the educational material within the instance of the PDF file before providing educator content to the student. The educator content would then be superimposed on the instance of the PDF file at the appropriate section. The timing data and location data may relate to specific portions of the student-specific educator content, such that different portions of the content are superimposed at different times and in different locations.

The educator device (11) may be any appropriate communications device. The educator device (11) may include a processor (65) for executing the functions of components described below, which may be provided by hardware or by software units executing on the educator device (11). The software units may be stored in a memory component (67) and instructions may be provided to the processor (65) to carry out the functionality of the described components. In some cases, for example in a cloud computing implementation, software units arranged to manage and/or process data on behalf of the educator device (11) may be provided remotely. Some or all of the components may be provided by a software application downloadable onto and executable on the educator device (11).

The educator device (11) may also include a PDF file interaction interface (61) for interacting with a PDF file instance for a particular student, such as student A, or for individuals or a group of students. Interacting with a PDF file instance may include providing educator content such as annotations, input, etc. It is envisaged that educator content may be provided for multiple PDF file instances for a group of students, for example, students in a class, or a sub-set of a class. It is also anticipated that the educator content may be for specific students. For example, an educator may select some form of additional content for a student and allocate this additional content to the student using the PDF file interaction interface (61). This content is then automatically pushed from the educator device (11) to the student device (5) via the computerized server (3). The educator content is associated with a relevant PDF file or instance thereof so that it may be superimposed onto the PDF file or instance thereof at a later, appropriate time. The educator may also use the PDF file interaction interface (61) to control where the student-specific educator content will appear in the PDF file or instance thereof, and may also set rules relating to the time, events or conditions on which the educator content will be superimposed on the PDF file or instance thereof.

An activity monitoring component (52) may be provided at the student device (5) for monitoring the student's interaction with the PDF file and a corresponding student monitoring component (20) of the server (3) may store and analyse the student interaction.

The server (3) may include a student data analytics component (12) for analysing data relating to students from the data obtained by the student monitoring component (20). This may include data mining to extract data relating to a student. A general student data component (13) may gather and analyse data relating to a group of students, such as in a common grade or class. A general profile (14) of such a group of students may be generated for comparison purposes.

The student monitoring component (20) may include a student profile (21) for a particular student which is based on the gathered data for that student (e.g. student A) and may be compared to the general profile (14). A student identifier (22) for example with a login user name may be provided for identifying the student and monitoring their resources. An updates component (23) may be provided for updating the student profile (21) and a scheduling component (24) may be provided for scheduling assessments and also for altering an educator if required. The server (3) may also include an educator component (16) for communicating with an educator device (11).

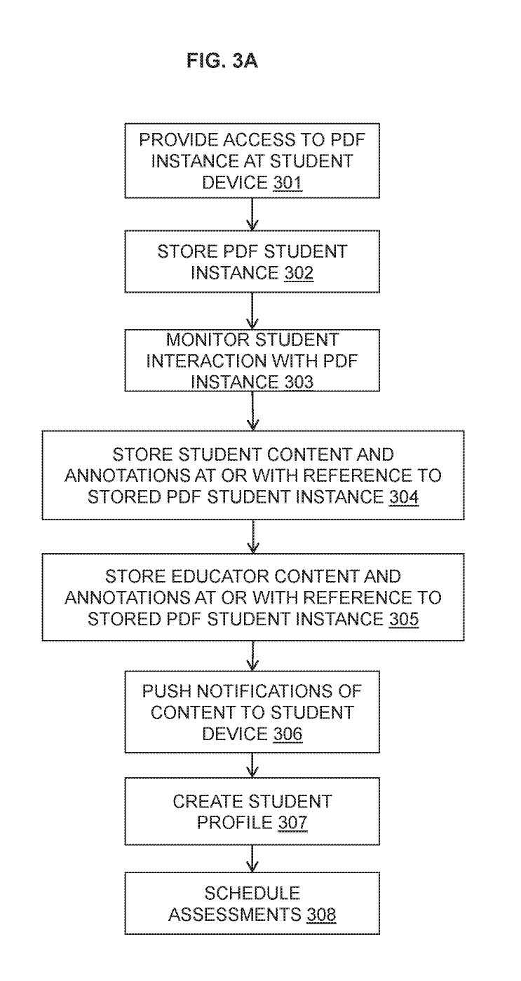

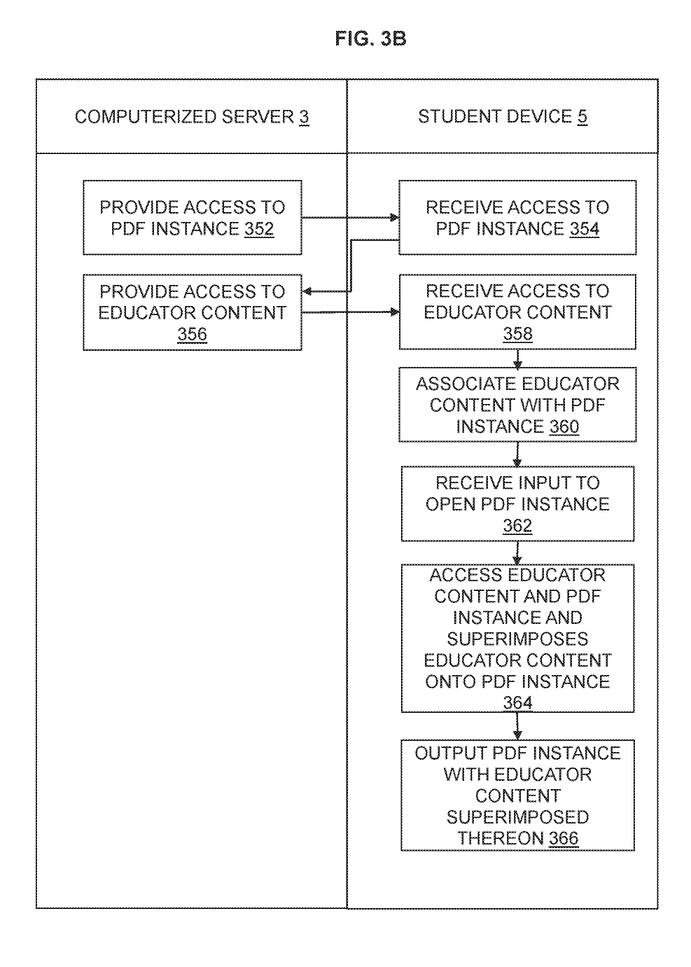

FIG. 3A is a flow diagram which shows an example embodiment of a method carried out at a server (3) of the described educational infrastructure.

Access to a PDF file may be provided (301) at a student device. Access by the student device may be via a browser or an application. In some cases, the PDF file may be downloaded at the student device. A student's PDF file instance including additional content may be backed up and stored (302) at a data store of a server and accessed by the student device if data is lost at the student device. In other implementations, the access provided may be remote access. Content additions or annotations made to a downloaded instance may be monitored and stored by the server with push notifications sent to the student device. Multiple PDF file instances of different learning material may be provided for access by each student device.

Any interaction of the student via his or her device with a PDF file instance may be monitored (303). Student provided content or annotations or additions may be stored (304) at or with reference to the stored PDF file instance for that student providing an individualized version of the PDF file. In addition, educator provided content may be stored (305) at or with reference to the stored PDF file instance for that student providing a further unique, individualized version of the PDF file with personal or group feedback from an educator.

Push notifications of content, references, or annotations of a PDF file instance may be provided (306) to a student device from an educator device via the server.

The method may also include creating (307) a student profile based on their interaction and scheduling (308) assessments and feedback based on the student profile. Assessments may be pushed to the student device as additional content for a PDF file.

In one embodiment, an educator may provide content by dropping content into a PDF file at a desired location using a browser of the educator's device. The educator may provide content for a class of students, a sub-set of the class, or an individual. The content is sent by the server to the student devices of the students to which the content applies and is added to their instances of the PDF file by push notifications to their devices.

The students' instances of the PDF file including received educator content as well as their own annotations and additions are stored at their devices and also backed up to the server. The back-up may be to a local server and/or to a cloud based server.

The swim-lane flow diagram of FIG. 3B illustrates a method for providing personalized electronic learning material in an educational infrastructure.

The computerized server (3) provides (352) access to an instance of a PDF file to the student device (5). This may include the student first identifying him- or herself to the computerized server (3), for example, by way of a user name and unique individual password or other suitable identification data. The student device (5) receives (354) access to the instance of the PDF file from the computerized server (3). The instance of the PDF file contains learning material and, in this embodiment, receiving access to the instance of the PDF file includes downloading the instance of the PDF file from the computerized server (3) onto the student device (5), via a network, for storage on the student device (5). It should, however be appreciated that in an alternative embodiment, the student device may be operable to remotely access and utilize an instance of the PDF file stored at the computerized server.

The computerized server (3) provides (356) access to the student-specific educator content to the student device (5). The content may be specific to the student and access thereto may have been pushed from an educator device. The student device (5) receives access (358) to the student-specific educator content from the computerized server (5). In this embodiment, receiving access to the educator content includes downloading the content from the computerized server (3) onto the student device (5) for storage thereat. However, in an alternative embodiment, the student device may remotely access and utilize the educator content stored at the computerized server.

The student device (5) associates (360) the student-specific educator content with the instance of the PDF file. For example, the student-specific educator content may reference one of multiple instances of PDF files, in which case the student-specific educator content is associated with the relevant instance of the PDF file. In the present embodiment, where the instance of the PDF file and the educator content are downloaded and stored on the student device, the instance of the PDF file and the educator content are associated with each other at the student device, while in another embodiment, where they are remotely accessed and utilized by the student device, the instance of the PDF file and the educator content may be associated with each other at the computerized server.

The student device may receive (362) student input instructing the student device (5) to open the instance of the PDF file. The input may be received via a user input device such as a touch-screen associated with the device. In an embodiment where the instance of the PDF file and the educator content are remotely accessed and utilized by the student device, the student device may communicate the input to the computerized server (3) via the communication network (10).

Responsive to receiving the input, the student device (5) accesses (364) the instance of the PDF file, accesses the student-specific educator content associated with the instance of the PDF file and superimposes the student-specific educator content onto the instance of the PDF file. The student device (5) outputs (366) the instance of the PDF file having the student-specific educator content superimposed thereon to a display associated therewith for display to the student.

In should be appreciated that in some embodiments, the educational infrastructure may operate on a cloud principle in which a software application is hosted by the computerized server and in which the student device utilises the software application via a communication network. In such an embodiment, various stages described above as being performed at the student device may be performed at the computerized server or may be performed jointly by the student device and computerized server (e.g. with some operations being performed at the student device and other operations being performed at the server).

As mentioned previously, superimposing the student-specific educator content onto the PDF file or instance thereof does not alter the PDF file or instance thereof. The PDF file or instance thereof thus remains intact and the student-specific educator content does not alter the structure of the PDF file or instance thereof. The PDF file or instance thereof may thus be safely regarded as untouched and original.

In this way, an educator using an educator device may drop student-specific content into individual or groups of students' instances of relevant PDF learning material files without altering the PDF file or instance thereof. The educator content may be superimposed into relevant PDF files or instances thereof without student intervention. Furthermore, portions of the content may be superimposed at appropriate times and in appropriate locations within the PDF files or instances thereof.

Turning now to the second aspect of this invention there are provided PDF books in which a plurality of phrases or passages or both in the text of the book are highlighted in a manner such that an assembly of the highlighted phrases and passages, together with any other information that is required, forms a summary of the book.

Different highlighting may be used for different purposes and different phrases or passages may be highlighted differently for such purposes. The type of highlighting could be different coloured backgrounds, underlining, or anything rendering the phrases or passages clearly identifiable.

A highlight should be understood as meaning a decoration of some sort to make a phrase or passage more prominent in the text. To highlight specific phrases or passages in the document, that element needs to be located. The element could be anywhere in the PDF file. To pinpoint the element, a page number and/or a page offset and coordinates (e.g. x, y coordinates) on the page are used to identify the start and the end of a highlight block. The highlight is presented in an additional layer over the base layer that contains the text.

PDF books can also be enriched with other relevant content. Resources such as images, videos, URL links, and other documents can be attached at specific elements to enrich the existing content with additional information.

To extract a summary from such a PDF book it is assumed that the highlights made in the book indicate important areas that can be included in a summary. The summary may thus consist of all the highlighted text, and some context around the highlight. The summary may also include relevant structural information, such as chapter names and headings, to give a user more context about from where in the book specific parts were extracted. The extracted parts should be in the order in which they appear in the book.

Elements where phrases are highlighted may then be extracted and placed, in the order they appear in the original pages, on to a new summary page. This new summary page will thus contain all of the highlighted elements of the PDF book. Relevant structural content may also be inserted. The elements that make up the content of the pages are generally small sections and paragraphs, so showing the whole element should give the necessary context for the highlight. If the book has resources that were attached to enrich the content, these are also shown at the relevant sections.

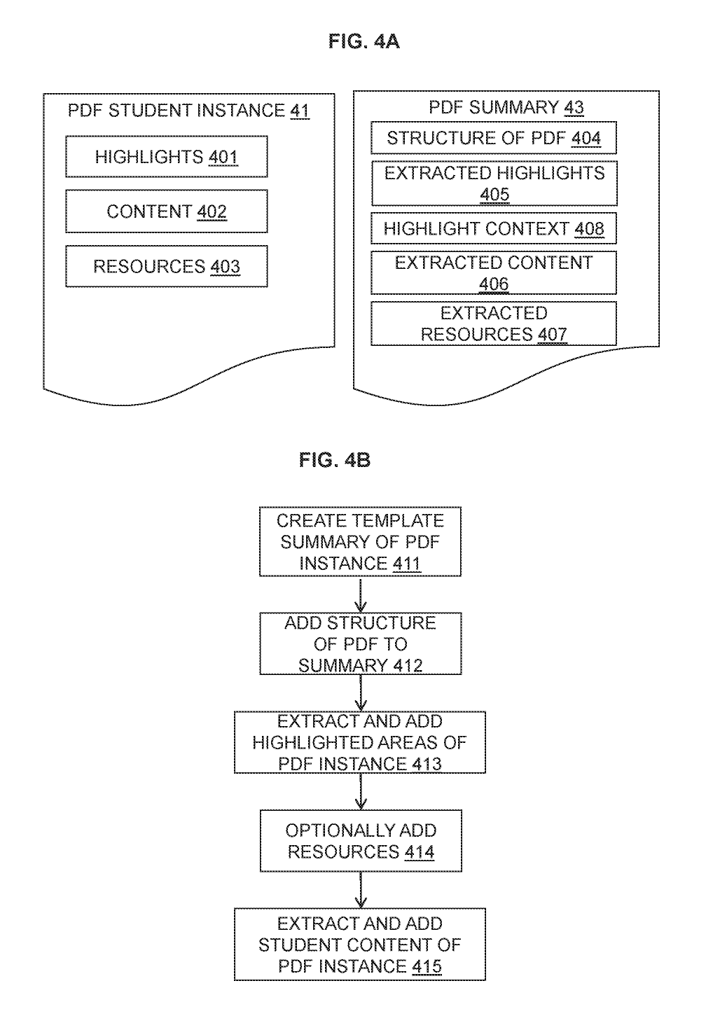

Referring to FIG. 4A, a schematic diagram shows a PDF file instance (41) of a student (“PDF student instance”) and a generated PDF file summary (43) (“PDF summary”). The PDF file instance (41) may include student provided highlights (401), content (402) and referenced resources (403).

The PDF file summary (43) may include the structure of the PDF file (404) such as the contents and titles, extracted highlights (405) as described above together with context (408) for the highlights obtained from the PDF file instance (41). The PDF file summary (43) may also include extracted content (406) from the PDF file instance (41) and extracted resource references (407) from the PDF file instance (41).

Referring to FIG. 4B, a flow diagram shows an example embodiment of a method of providing a PDF file summary (41). The method may include creating (411) a template summary of the PDF file instance. This may include adding (412) the structure of the PDF file such as the contents and headings to the summary.

Highlights of the PDF file instance may be extracted and added (413) to the summary together with resource references (414) and other student or educator added content (415).

The third aspect of this invention provides a PDF book in which the book is enhanced by inserting interactive assessments in the content of the book that become part of the book and require no linking to external applications or websites. The assessments may be configured to test a student's knowledge about a section of the electronic book. Meta-data may be attached to questions and activities and scores can be allocated to each question in order to assess a student's knowledge about different aspects of a subject. Scores may be developed that are sent to an educator for immediate or later evaluation.

Assets or assessments may be created by educators or publishers and inserted into the book.

Alternatively, assets or assessments may be scripted by publishers and files may be embedded into the book's source code. It should be noted that these additional resources are generally published into the PDF file after the delivery of the PDF file to the student. In other words, delivery of additional content to students generally happens “on the fly” and not with the creation of the PDF file, although the latter is also possible. Delivery of additional content may be by push notification of the content to the PDF file instance of the student. Once the assets are in the book a student may access them by clicking on the relevant icon and completing the activity. When the student is done, a score may be presented to the student. This score may only reflect the overall attempt of the student and a more detailed score may be sent to the computerized server for perusal by an educator.

The assets may assume many different forms. It may require a student to choose options by presenting the student with a question and a number of possible answers. The student must choose the correct answer. It may assume the form of a puzzle in which an image is shuffled and the student is required to correct the image by swapping pieces in say a 4×3 grid. The asset may be a word builder in which a question is presented to the student and the answer must be built from a number of jumbled letters. The asset may require the matching of items wherein the student must match up to four items on the left with their related items on the right. The items on the right are swapped out until the matches are correct. The asset may require a fill in wherein a statement or equation is presented to the student with a blank block that requires completion in order to continue the assessment. The asset may require a spelling of a word to be corrected by swapping out wrongly ordered letters.

The system allows PDF books to be extended with additional content by students. Arbitrary additional data, either files or text, can be attached to points in the book, and then viewed inside the book itself when opened through an appropriate book renderer. The system consists of two parts: a web interface which lets students attach items to books, and a mobile device application which can render the books along with the additional content. The mobile device application is specifically designed to understand how to render the additional content in the book.

An educator may make use of a web interface which renders the book as it appears on the student devices. The educator can drag and drop items from a variety of categories (e.g. text, images, URLs, videos, etc.) into the book. The interface indicates where the items are attached, and they can be moved around or removed using the same drag/drop functionality. The items become immediately accessible by push notifications, and users with the book open can simply click a button to receive the latest items. While only educators can add content to the book from the web interface, students can add notes and sketches of their own directly through the application. The result of the combined activity of the educator and the student is a unique PDF file which exists between the particular educator and the student since there is only one version per student which contains her/his notes, additions and sketches as well as those of the educator. This results in a personalized PDF file.

As before, it should be appreciated that all content, whether as originally published, created by the student or created by the educator, is synchronized on the server and stored in the data store in real time or periodically as and when access to the server is available, thereby enabling complete recovery of content by students and educators alike in the event of device malfunction, failure or switchover.

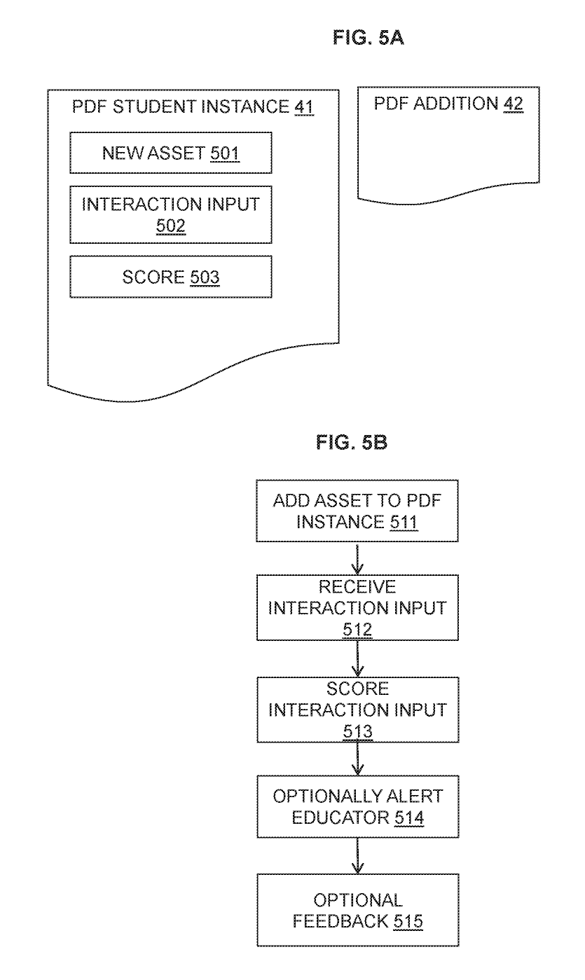

Referring to FIG. 5A, a schematic diagram shows a PDF file instance (41) of a student with PDF file additional content (42) provided including assets which provide assessments to the student. The PDF file instance (41) may be updated with new assets (501) as described above and the student interactive input (502) may be recorded and a score (503) generated.

Referring to FIG. 5B, a flow diagram shows an example embodiment of this aspect of providing additional content for student assessment as carried out by the server (3).

An asset may be added (511) to a PDF file instance, for example on the fly and without recourse to external resources. Interactive input by the student is received (512) and scored (513) or otherwise assessed. Optionally, an educator alert or input may be activated (514) and optionally feedback may be provided (515) to the student and to the educator.

In implementing the fourth aspect of this invention a web-based audio-visual content creation tool comprises a student device and a computerized server side wherein the student side is displayed in a web browser with a large blank area (“canvas”). Command palettes, a screen toggle area, and control buttons are also provided to allow a student to choose operations selected from, or comprising, drawing lines, placing images, and erasing images in the blank area. The data generated is sent to the computerized server in pieces by the student device and reassembled by the server before storage.

The screen toggle area allows the student to create multiple virtual screens and move between them both before and during the recording. The control buttons allow the student to start, pause, and stop the recording at any time, as well as previewing the recording made so far, or cancelling it and starting over.

A timestamp is captured with each event to be used to synchronize audio data with the video data for playback with the audio replay determining the pace of the playback with video events being consumed as fast or as slow as required to keep pace with the audio playback.

The student side of the system uses an HTML5 canvas to capture video content, with an Adobe Flash component for capturing audio. The Flash component makes use of Adobe's Alchemy API to include a C++ component, which performs real-time transcoding of the audio data from the raw format captured by Flash, into the Ogg format. This format is much smaller (approximately 1/20th), and allows the data to be streamed to the computerized server directly, even on slower connections. The data is chunked into segments, each of which is transcoded independently, and then sent on to the computerized server as the recording continues. Thus, by the time the recording is finished, most of the data is already held by the server.

Video data is captured as a series of actions on the canvas. Each action the user makes is stored, forming a history of actions, which can be replayed from an arbitrary point, or modified as needed. This allows undo/redo operations to be implemented, as well as in-progress replays. The timestamp captured with each event is used to synchronize the audio with the video for playback. Thereafter, the audio replay determines the pace of the playback, and video events will be consumed as fast or as slow as required to keep pace with the audio replay.

The system is designed to create content that has a very low disk size footprint; can be rapidly created by even very modest server hardware, by leveraging the power of the student to perform the bulk of the work; can be created on students communications devices with relatively low outgoing bandwidth; and does not require post-processing to scale to a variety of resolutions for consumption, as well as being immediately available for use once complete.

The student can begin drawing on the canvas before starting the recording, to allow it to be pre-set up. The screen toggle area allows the student to create multiple virtual screens in the video, much like a presentation, and move between them at will, both before and during the recording. The control buttons allow the student to start, pause, and stop the recording at any time, as well as previewing the recording made so far, or cancelling it and starting over.

The server-side consists of a few services designed to receive data from the student, and store it. The data is sent to the server in pieces by the student communications device, and then reassembled by the server before storage. No additional processing is needed: the data is stored as-is, and is immediately ready for use by students.

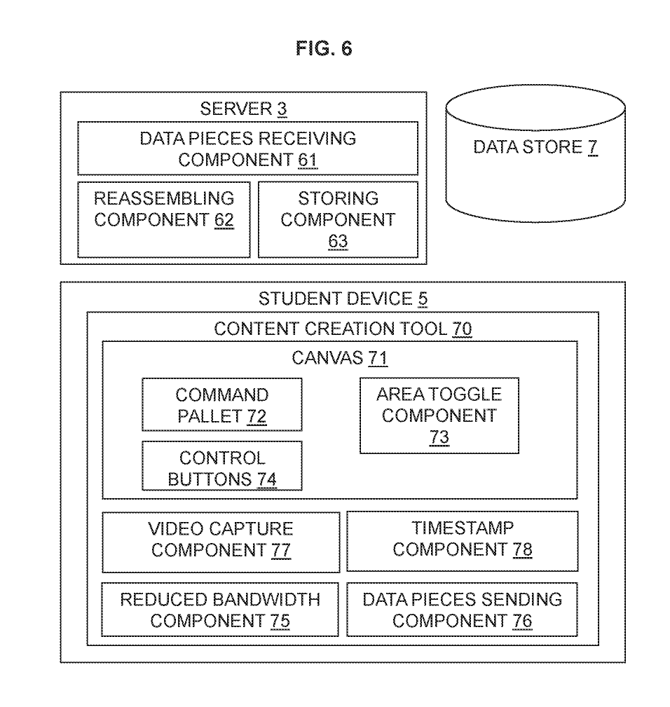

Referring to FIG. 6, a block diagram shows components of the educational infrastructure that provide the described fourth aspect.

A student device (5) is provided with a content creation tool (70) which includes a canvas (71) having user tools for inputting content such as a command palette (72), control buttons (74), and an area toggle component (73) as described above.

The content creation tool (70) may include a video capture component (77) and a timestamp component (78) for capturing timeslots of the user content of the canvas (71).

Data pieces of the generated content may be sent by a data pieces sending component (76) to a server (3) using a reduced bandwidth component (75).

The server (3) may include a data pieces receiving component (61), a reassembly component (62) and a storing component (63) for storing the reassembled pieces in a data store (7). The server (3) may receive and reassemble and store data for multiple student content providers.

It will be appreciated that different components of the various aspects and embodiments described may be used in combination with components of other aspects and embodiments.

It will be understood that an infrastructure set up according to the invention for the purpose of educators educating multiple students utilizing the infrastructure has considerable benefit over current education infrastructures.

Using an infrastructure as proposed by the present invention, educators are in full control of a class of students and form a pivotal role in the learning environment. They can push content and resources to the students' communications devices and conduct assessments and class tests via the personalized education framework that results from use of the infrastructure of the invention.

It is envisaged that educators may use PDF books forming part of the official curriculum and add educational content in the form of various different items such as Word™ documents, other PDF files, videos, text, website links and more to create a very much enhanced PDF book. The PDF books and added educational content are in turn synchronized and stored by the server against institutional and student profiles, thereby allowing complete recoverability in the event of data loss by students.

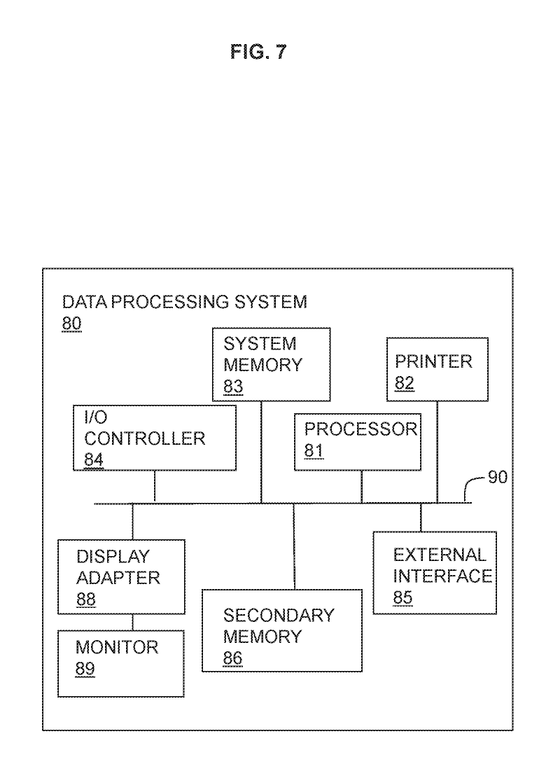

FIG. 7 illustrates an example of a data processing system (80) in which various aspects (e.g. the computerized server (3)) of the disclosure may be implemented. The data processing system (80) may be suitable for storing and executing computer program code. The various participants and elements in the previously described system diagrams may use any suitable number of subsystems or components of the data processing system (80) to facilitate the functions described herein.

The data processing system (80) may include subsystems or components interconnected via a communication infrastructure (90) (for example, a communications bus, a cross-over bar device, or a network). The data processing system (80) may include at least one central processor (81) and at least one memory component in the form of computer-readable media.

The memory components may include system memory (83), which may include read only memory (ROM) and random access memory (RAM). A basic input/output system (BIOS) may be stored in ROM. System software may be stored in the system memory (83) including operating system software.

The memory components may also include secondary memory (83). The secondary memory (83) may include a fixed disk, such as a hard disk drive, and, optionally, one or more removable-storage interfaces for removable-storage components.

The removable-storage interfaces may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces may also be in the form of ports or sockets for interfacing with other forms of removable-storage components such as a flash memory drive, external hard drive, or removable memory chip, etc.

The data processing system (80) may include an external communications interface (85) such as a network adapter for operation of the data processing system (80) in a networked environment enabling transfer of data between multiple data processing systems (80). Data transferred via the external communications interface (85) may be in the form of signals, which may be electronic, electromagnetic, optical, radio, or other types of signal. The external communications interface (85) may enable communication of data between the data processing system (80) and other data processing systems including servers and external storage facilities. Web services may be accessible by the data processing system (80) via the communications interface. The external communications interface (85) may also enable other forms of communication to and from the data processing system (80) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (81).

A computer program product may be provided by a non-transient computer-readable medium, or may be provided via a signal or other transient means via the external communications interface (85).

Interconnection via the communication infrastructure (90) allows a central processor (81) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the data processing system (80) either directly or via an I/O controller (84). These components may be connected to the data processing system (80) by any number of means known in the art, such as a serial port.

One or more monitors (89) may be coupled via a display or video adapter (88) to the data processing system (80).

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

It will also be understood that numerous variations may be made to the implementation of the various aspects of the invention as described above without departing from the scope thereof.

Also, it is not necessary that all aspects of the invention be used in any one infrastructure. In particular, it is foreseen that any number of suitable communications devices may be used by students to access and interact with the infrastructure including, but not limited to, mobile phones, personal computers, personal digital assistants and other so-called “smart” devices to name but a few. The infrastructure provides a convenient platform whereby students may access and interact with their learning material from any number of suitable electronic devices, thereby drastically increasing the availability of learning material and also enhancing the learning and educating experience.

Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented method for providing personalized electronic learning material in an educational infrastructure, the method performed by a student device associated with a student and including a software application resident therein, the method including:
receiving, from a computerized server, access to a portable document format (PDF) file, the PDF file comprising learning material;
receiving, from the computerized server, access to student-specific educator content, the content being specific to the student and access thereto having been pushed to the student device from an educator device via the computerized server;
associating the student-specific educator content with the PDF file; and
responsive to receiving student input to open the PDF file:
accessing the PDF file;
accessing the student-specific educator content associated with the PDF file;
superimposing the student-specific educator content onto the PDF file; and,
outputting, to the student device, the PDF file including the student-specific educator content superimposed thereon.

2. The computer-implemented method as claimed in claim 1, wherein the educational infrastructure operates on a cloud principle in which the software application is hosted by the computerized server and in which the student device utilises the software application via a communication network.

3. The computer-implemented method as claimed in claim 1, wherein the software application performs the steps of: accessing the PDF file; accessing the student-specific educator content associated with the PDF file; superimposing the student-specific educator content onto the PDF file; and, outputting the PDF file including the student-specific educator content superimposed thereon.

4. The computer-implemented method as claimed in claim 1, wherein receiving access to a portable document format (PDF) file includes receiving access to an instance of a PDF file stored at the computerized server.

5. The computer-implemented method as claimed in claim 4, wherein associating the student-specific educator content with the PDF file includes storing the student-specific educator content at the computerized server in association with the instance of the PDF file.

6. The computer-implemented method as claimed in claim 5, wherein superimposing the student-specific educator content onto the PDF file or instance thereof does not alter the PDF file or instance thereof.

7. The computer-implemented method as claimed in claim 1 wherein superimposing the student-specific educator content onto the PDF file is performed without intervention from the student.

8. The computer-implemented method as claimed in claim 1, wherein the student-specific educator content includes timing data, and wherein the timing data instructs a point in time at which the student-specific educator content is superimposed onto the PDF file.

9. The computer-implemented method as claimed in claim 1, wherein the student-specific educator content includes location data specifying locations within the PDF file at which the student-specific educator content is to be superimposed.

10. A computer-implemented method for providing personalized electronic learning material in an educational infrastructure, the method performed by a computerized server capable of communicating with a student device associated with a student and including a software application resident therein, the method including:
providing, to the student device, access to a portable document format (PDF) file, the PDF file comprising learning material; and
providing, to the student device, access to student-specific educator content, the content being specific to the student and access thereto having been pushed from an educator device, wherein the student device is configured to associate the student-specific educator content with the PDF file and superimpose the student-specific educator content onto the PDF file for output to the student device.

11. The computer-implemented method as claimed in claim 10, wherein the educational infrastructure operates on a cloud principle in which a software application is hosted by the computerized server and in which the student device utilises the software application via a communication network.

12. The computer-implemented method as claimed in claim 11, wherein the method includes:
associating the student-specific educator content with the PDF file; and
responsive to receiving, via the communication network, student input to open the PDF file:
accessing the PDF file;
accessing the student-specific educator content associated with the PDF file;
superimposing the student-specific educator content onto the PDF file; and
outputting, to the student device via the communication network, the PDF file including the student-specific educator content superimposed thereon.

13. The computer-implemented method as claimed in claim 12, wherein providing access to a portable document format (PDF) file provides access to an instance of a PDF file, and wherein associating the student-specific educator content with the PDF file stores the student-specific educator content at the computerized server in association with the instance of the PDF file.

14. A system for providing personalized electronic learning material in an educational infrastructure, the system including a student device associated with a student and including a software application resident therein, the student device including:
a PDF receiver configured to receive, from a computerized server, access to a portable document format (PDF) file, the PDF file comprising learning material;
an educator content receiver configured to receive, from the computerized server, access to student-specific educator content, the content being specific to the student and access thereto having been pushed to the student device from an educator device via the computerized server;
an associator configured to associate the student-specific educator content with the PDF file; and
a PDF file interaction interface configured to, in response to receiving student input to open the PDF file:
access the PDF file;
access the student-specific educator content associated with the PDF file;
superimpose the student-specific educator content onto the PDF file; and
output, to the student device, the PDF file including the student-specific educator content superimposed thereon.

15. The system as claimed in claim 14, including a computerized server configured to communicate with the student device, the computerized server including:
a PDF provider configured to provide, to the student device, access to a portable document format (PDF) file, the PDF file comprising learning material; and
an educator content provider configured to provide, to the student device, access to student-specific educator content, the content being specific to the student and access thereto having been pushed from an educator device, wherein the student device is configured to associate the student-specific educator content with the PDF file and superimpose the student-specific educator content onto the PDF file for output to the student device.
